(19) United States
(12) Patent Application Publication
(10) Pub. No.: US 2008/0209477 A1
(43) Pub. Date: Aug. 28, 2008

(54) Promotion and Degradation of Soft Erasure Information Using Crc and Proceding Decoder Information

(75) Inventors: Arie Geert Cornelis Koppelaar, Giessen (NL); Onno Eerenberg, Oisterwijk (NL); Marcus Gerardus Verhoeven, Deurne (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,137

(22) PCT Filed: Jan. 16, 2006
(86) PCT No.: PCT/IB2006/050150

§ 371 Date: Jul. 17, 2007

Related U.S. Application Data
(60) Provisional application No. 60/644,542, filed on Jan. 18, 2005.

(51) Int. Cl. H04N 7/16

(52) U.S. Cl. 725/62

(57) ABSTRACT

This invention describes a system and method for assigning four levels of priority to erasures and promoting/degrading erasures by confining the number of locations to which erasures are assigned using decoder information from a preceding RS decoder and a CRC. The preceding decoder produces soft-erasure information based on blocks of 184 bytes, while the CRC can cover blocks of sizes up to 4,080 bytes whereas the invention combines the CRC with information of the preceding decoder erasures such that the combination is assigned in multiples of 184 bytes.

The present invention relates to Digital Video Broadcasting transport for hand-held devices, DVB-H, which are inherently low-power devices. More particularly, the present invention relates to a system and method for using erasure information in DVB-H.

Digital Video Broadcasting-H (DVB-H) is a new standard for providing Digital Video Broadcasting services to hand-held devices (e.g., mobile phones), see, DVB-H Implementation Guidelines, Draft ETSI TR 1XX XXX, V0.1.0, (2004-09) and DVB Specification For Data Broadcasting, Modified Version of DVB-H Additions Including CA Support, Final draft ETSI EN 301 192 V1.4.1, DVB-H201r1, the entire contents of both of which are hereby incorporated by reference. A provision is made in these guidelines/specifications to support low-power receiver implementations. For example, DVB-S, C, T information is broadcast in so-called Transport Streams in which traditionally several MPEG-2 encoded programs are multiplexed.

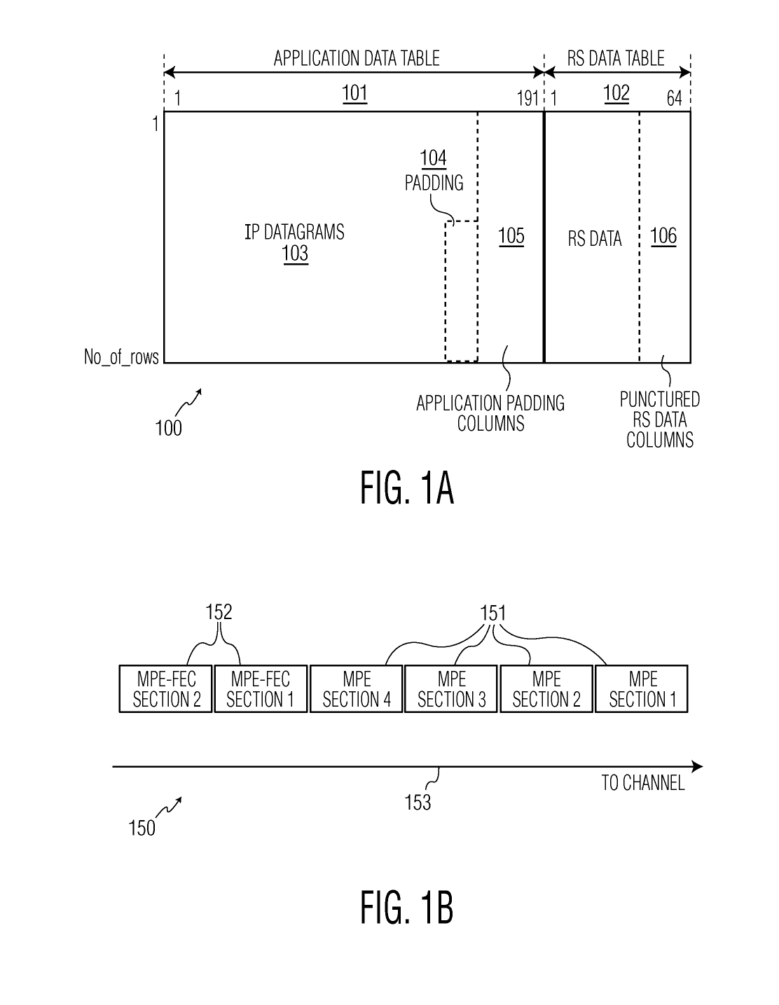

In order to take advantage of more advanced source-coding standards, such as MPEG-4, and to anticipate the smaller display size of hand-held devices, the video data is encapsulated in IP packets and transmitted using so-called Multi Protocol Encapsulation (MPE) sections. Referring now to FIG. 1a, an MPE-FEC frame 100 is illustrated comprising an Application data table 101 and a Reed-Solomon (RS) data table 102. The MPE-FEC frame format 100 is specified by ETSI as the transmission frame format.

A DVB-H system is made more robust by protecting the MPE sections with an extra layer of Forward Error Correction (FEC). The additional layer of FEC makes use of a Reed-Solomon code. The RS code employed is a byte-oriented code with a Hamming distance of 65 (unpunctured version). This allows the correction of up to 32 errors (i.e., position and value of the error is unknown) or 64 erasures (errors for which the locations are known) per word of 255 bytes (unshortened and unpunctured code word). Therefore, the proper use of reliable erasure information can have a significant impact on performance.

The system and method of the present invention provide a combined scheme for using the two sources of erasure information: Reed-Solomon (RS) and Cyclic Redundancy Check (CRC).

The system and method of the present invention has the following advantages:
compared with using only CRC for obtaining erasure information, smaller parts of the IP datagrams are erased, i.e., instead of the whole datagram (at most 4,080 bytes) fragments of 184 bytes are erased;
by introducing a medium priority erasure flag (t=8 corrected words), the full error-correcting capacity at the RS decoder of the channel demodulator is still available and the ability to check afterwards with the CRC to determine whether or not a missed correction took place is additionally available; and
compared with using only the RS decoder of the channel modulator (both the t=8 corrected errors and the uncorrectable words) for obtaining erasure information, the use of the CRC check allows confirmation of IP datagram fragment validity.

The system and method of the present invention thus provides multi-level erasure priorities that prevent the MPE-FEC decoder from being overloaded with erasures. At most 64 erasures can be granted, and by using several priority levels, in a preferred embodiment, the system and method of the present invention can grant the erasures in descending order of priority.

FIG. 1a illustrates the structure of an MPE-FEC frame;

FIG. 1b illustrates the sequencing of sections for transmission that corresponds to the MPE-FEC frame of FIG. 1a;

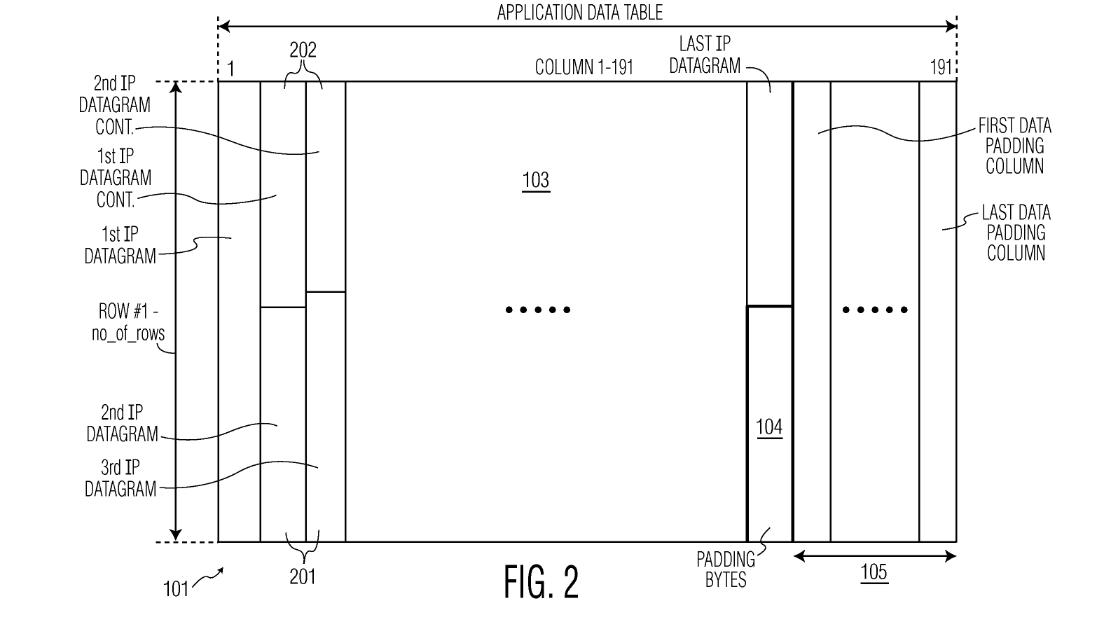

FIG. 2 illustrates an application data table part of an MPE-FEC frame;

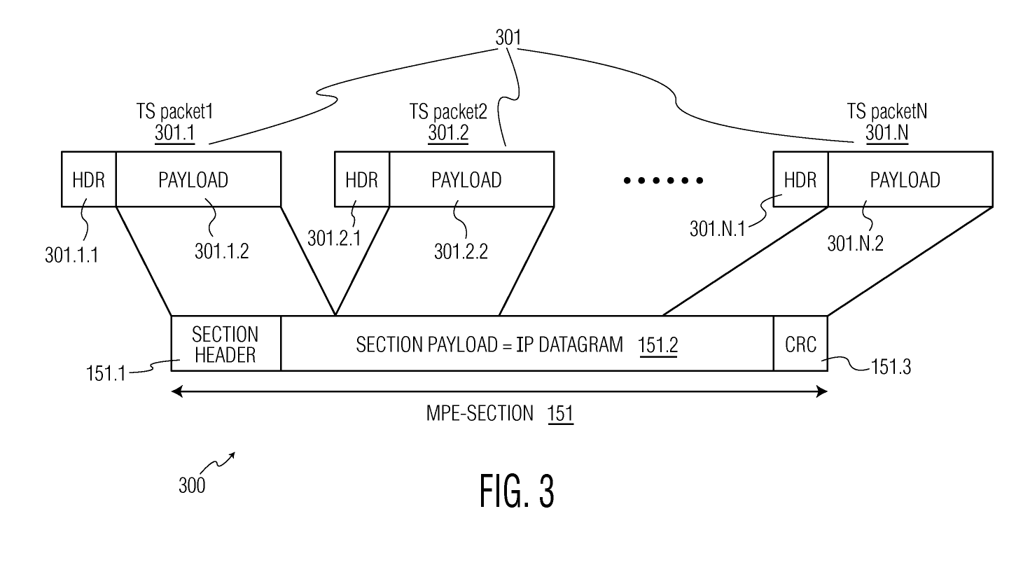

FIG. 3 illustrates how an IP datagram of an MPE-FEC frame is broken up into TS packets for transmission;

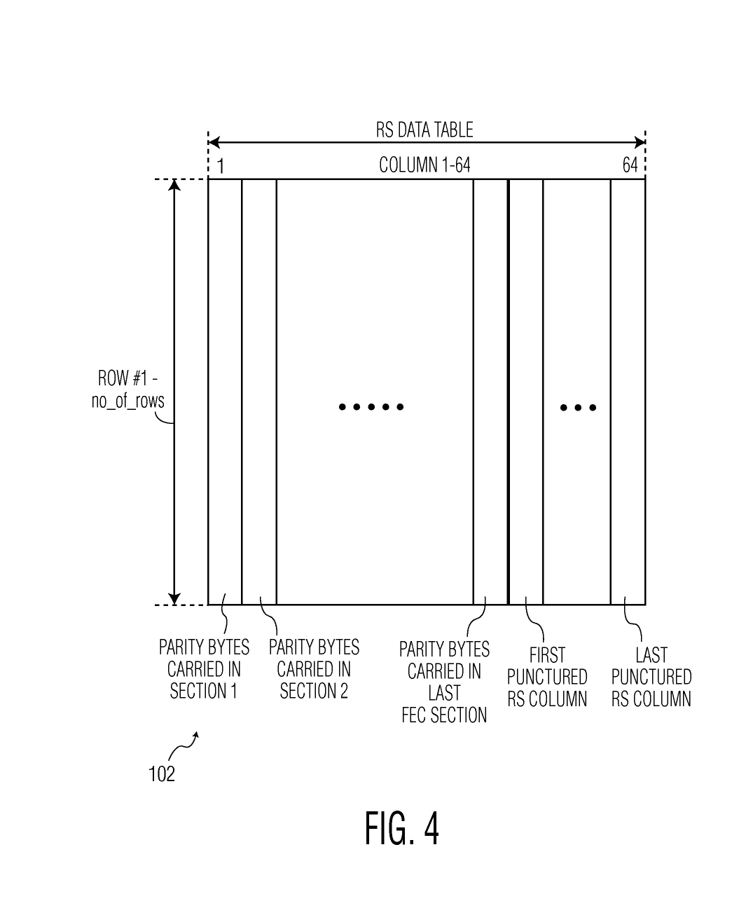

FIG. 4 illustrates a Reed-Solomon data table of an MPE-FEC frame; and

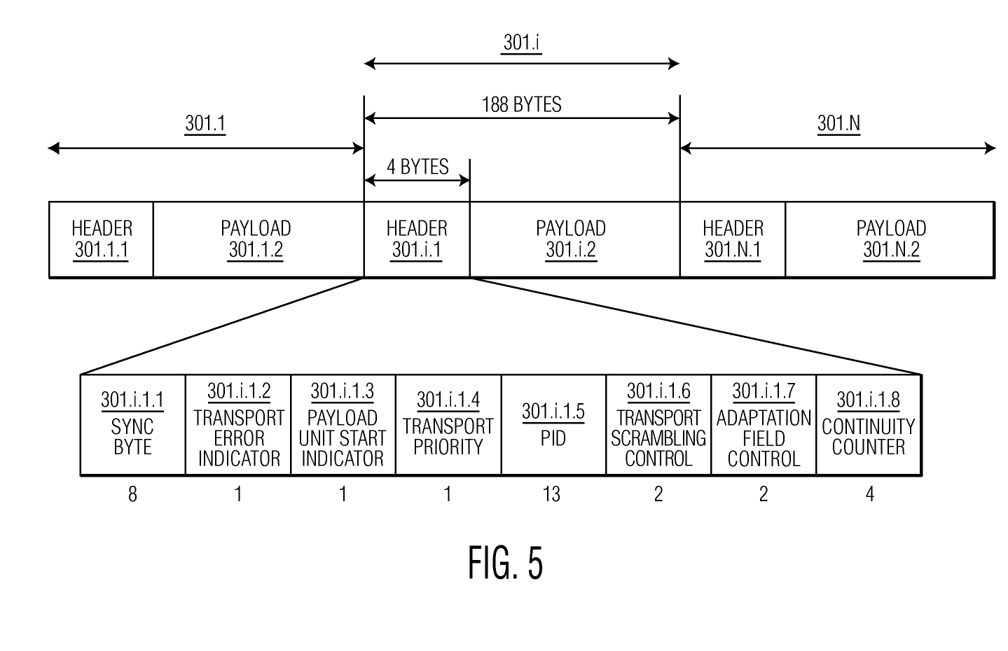

FIG. 5 illustrates a TS packet format for MEP-FEC frame transmission;

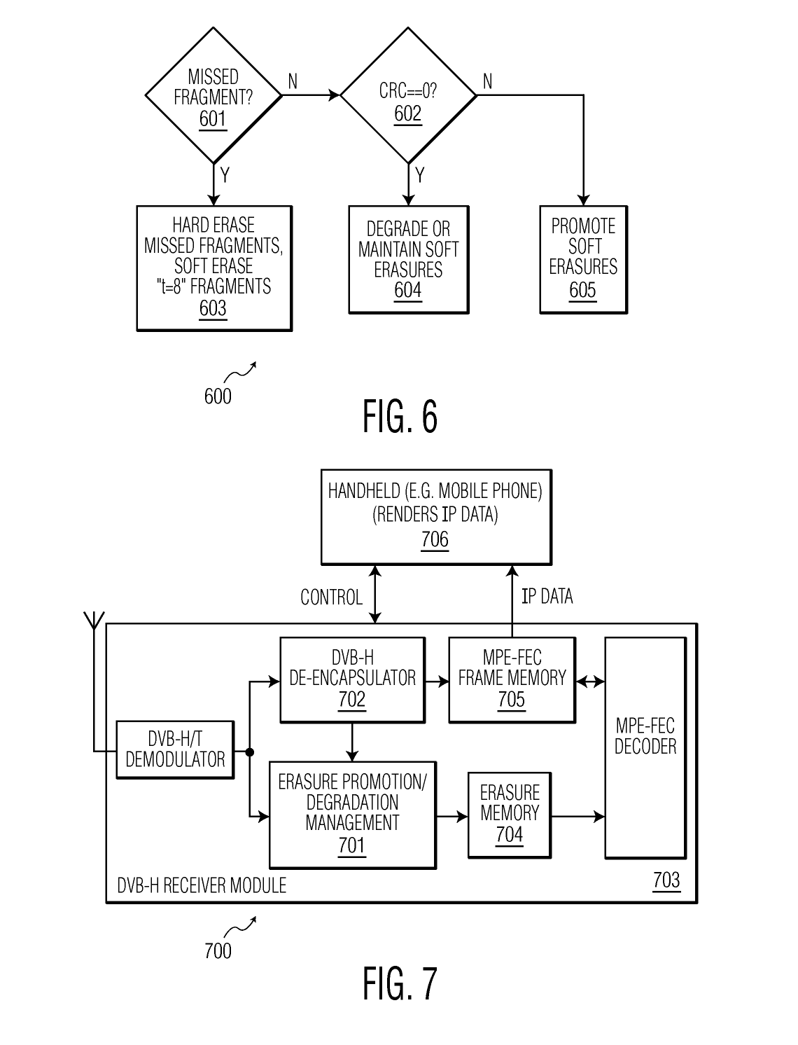

FIG. 6 illustrates a high-level flow diagram for promotion/degradation of erasure information;

FIG. 7 illustrates a DVB receiver modified to include a DVB-H de-encapsulator according to the present invention; and

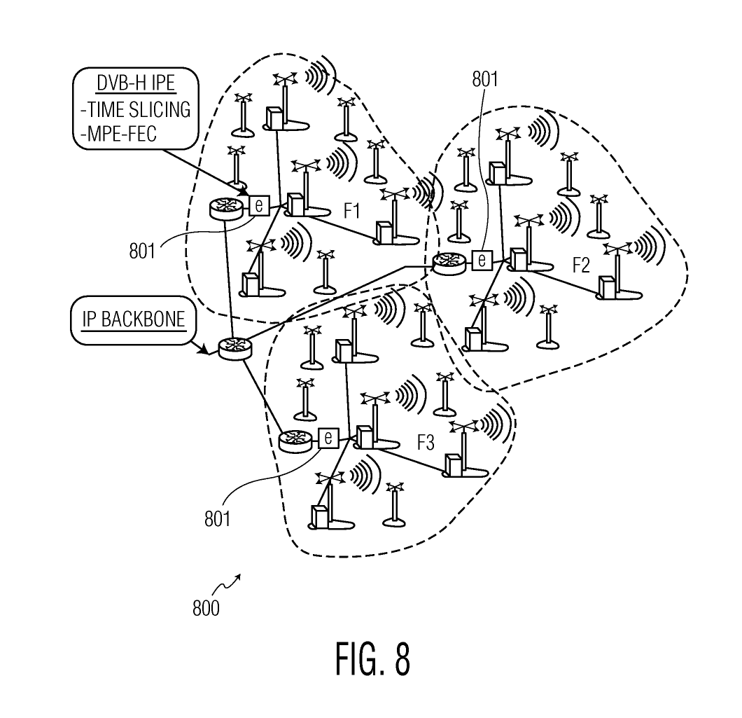

FIG. 8 illustrates a DVB-H dedicated network.

It is to be understood by persons of ordinary skill in the art that the following descriptions are provided for purposes of illustration and not for limitation. An artisan understands that there are many variations that lie within the spirit of the invention and the scope of the appended claims. Unnecessary details of known functions and operations may be omitted from the current description so as not to obscure the present invention.

The system and method of the present invention provide prioritized multi-level erasure that combines the RS and CRC sources of DVB-H soft erasure information.

Referring to FIG. 1a, an MPE-FEC frame 100 is a table of bytes with 255 columns and a flexible number of rows, where each row is a code word of a Reed-Solomon code. The number of rows is equal to 256, 512, 768 or 1024, and the actual used number of rows is signaled in the time_slice_fec_identifier_descriptor that is transmitted in PSI/SI tables (Program Specific Information/Service Information), see DVB Specification For Data Broadcasting, Modified Version of DVB-i H Additions Including CA Support, Final Draft, ETSI EN 301 192 V1.4.1, DVB-H201r1, the entire contents of which are hereby incorporated by reference. That is, the maximum allowed value for this size is 1,024, which makes the total MPE-FEC frame almost 2 Mb in size. Each position in the matrix holds an information byte. The left side 101 of the MPE-FEC frame, consisting of the 191 leftmost columns, is dedicated for IP datagrams 103 and possible padding 104, and is called the Application data table. The right side 102 of the MPE-FEC frame, consisting of the 64 rightmost columns, is dedicated to the parity bytes of the FEC code and is called the RS data table. Each byte position in the Application data table has an address ranging from 1 to 191 x No_of_rows. Similarly, each byte position in the RS data table has an address ranging from 1 to 64 x No_of_rows. Addressing in RS table is redundant, since section_length and section_number are known. Referring now to FIG. 1b, the IP datagrams are transmitted using so-called MPE sections 151, and the RS data is transmitted using so-called MPE-FEC sections 152.

IP datagrams are placed datagram-by-datagram in the Application data table, starting with the first byte of the first datagram in the upper left corner of the table and going downwards in the first column. The length of the IP datagrams may vary arbitrarily from datagram to datagram. The maximum size of an MPE section is 4096 bytes, so that IP datagrams up to 4,080 bytes can be encapsulated (4,096 bytes—12 bytes section header—4 bytes CRC). Immediately after the end of an IP datagram, the next IP datagram starts 201 (see FIG. 2). If an IP datagram does not end precisely at the end of a column, it continues at the top of the following column 202. When all IP datagrams have been placed in the Application table 101, any unfilled byte positions are padded 104-5 with zero bytes, which makes the leftmost 191 columns completely filled. The number of full padding columns 105 is signaled dynamically in each of the MPE-FEC sections (i.e., the sections that carry the RS parity bytes) with 8 bits.

The IP data is carried in MPE sections 151 in the standard DVB way, regardless of whether MPE-FEC is being used. An IP datagram is carried within one single MPE section. Referring now to FIG. 3, one Transport Stream (TS) packet payload 301 may contain one or more MPE sections 151 and one MPE section 151 may be fragmented into one or more TS packet payloads 301. This makes reception fully backwards-compatible with MPE-FEC-ignorant receivers. Each MPE section 151 includes a start address for the IP datagram that it contains. This start address indicates the position of the first byte of the IP datagram in the application data table and is signaled in the MPE header. The receiver is then able to place the received IP datagram in the correct byte position in the Application table and mark these positions as “reliable” for the RS decoder, provided the CRC-32 151.3 check shows that the section is correct.

The last section of the Application data table 101 contains a table_boundary flag that indicates the end of the IP datagrams within the Application data table. If all previous sections within the Application data table have been received correctly, the receiver does not need to receive any MPE-FEC section, and if Time-slicing is used it can go to sleep without receiving and decoding RS data.

If MPE-FEC sections 152 are received, the exact number of padding columns in the Application data table is indicated with 8 bits in the section header of the MPE-FEC sections 152, and it is only if RS decoding is performed that this value is required.

The parity bytes are carried in a separate, specially-defined section type having its own table_id.

Referring now to FIG. 4, with all the leftmost 191 columns of the Application data table filled in the MPE-FEC frame it is now possible, for each row, to calculate the 64 parity bytes of the RS data table 201 from the 191 bytes of IP data and possible padding. The code used is a byte-oriented |255,191, 65| Reed-Solomon code with:

field generator polynomial p(x)=x⁸+x⁴+x³+x²+1, and

code generator polynomial g(x)=(x+λ⁰)(x+λ¹)(x+λ²) . . . (x+λ⁶³), where λ=02_{HEX}

Each row of the Application data table contains one RS code word. Some of the right-most columns of the RS data table may be discarded, hence not transmitted, to enable puncturing. The exact amount of punctured RS columns does not need to be explicitly signaled and may change dynamically between frames. Having the RS data table 102 completely filled, the MPE-FEC frame 100 is ready to be inserted in the Transport Stream and can be transmitted.

At the receiver the MPE-FEC frame 100 must be reconstructed as well as possible to correct possible transmission errors with the MPE-FEC decoder (the RS code). The IP datagrams can be retrieved by extracting MPE sections 151 from the Transport Stream. The MPE section header signals the absolute address of the enclosed IP datagram in the Application data table 101. Similarly, the parity bytes of the RS code can be retrieved and put in the RS data table 102 by extracting MPE-FEC sections 152 from the Transport Stream. The MPE-FEC section header also contains the absolute address information of the enclosed parity column in the RS data table. Moreover, address information for the parity columns is redundant since only one parity column per MPE-FEC section 152 is transmitted and the MPE-FEC section header contains a sequence number from which the column position can be derived.

The last section of the Application data table contains a table_boundary flag, which indicates the end of the IP datagrams within the Application data table. If all previous sections within the Application data table have been received correctly, the receiver does not need to receive any MPE-FEC sections 152 and can go to sleep without receiving and decoding RS data if Time Slicing is used.

If, due to reception problems, one or more IP datagrams are not received, then the corresponding locations in the Application table can be erased, i.e., the decoder can be informed that these word positions are likely to be in error.

The MPE-FEC code has a Hamming distance of d=65, and therefore it is possible to correct up to t=32 random errors or e=64 erasures (byte positions from which the reliability information indicates that these positions are likely to be erroneous). In general, t error and e erasure decoding is possible provided that 2t+e<d.

There are two sources for erasure information, namely, Reed-Solomon decoding of the channel demodulator and a 32-bit Cyclic Redundancy Code that covers individual MPE and MPE-FEC sections. Each has shortcomings.

The RS code in the channel demodulator is a [204,188, 17] code. Traditionally, this RS code is decoded using an “error only” decoding strategy. The decoder of this code can be used for offering erasure information to the MPE-FEC. In such a mode, erasure information is given for each Transport Stream packet of 188 bytes. Erasures are assigned when the RS decoder cannot decode a word. In this event, the RS decoder sets the transport error indicator (tei) bit 301.i.1.2 in the Transport Stream packet header 301.i.1 to 1, see FIG. 5. The RS decoder also has a certain miss-correction probability. A miss-correction occurs when the number of errors is so large that the decoder “corrects” the received word to another code word. For correction of up to 8 errors (which is the maximum amount of errors that can be corrected with the RS [204,188,17] code), the miss-correction probability of the RS decoder is 3.6E-6. By confining the RS decoder to allow correction of up to 7 instead of 8 errors, the miss-correction probability improves to 5.8E-10. The advantage of using the RS decoder for obtaining erasure information is that the erased parts are smaller (maximum 188−4=184 bytes) than with the 32-bit CRC (maximum 4080 bytes).

The first TS packet of an MPE section contains the section header 151.1. Therefore this packet is important for knowing where to put an encapsulated IP datagram in an MPE-FEC frame 100. Therefore, when this packet is erased extra bookkeeping must be accomplished to place the remaining part of the MPE-FEC section in the MPE-FEC frame. An IP datagram fragment is defined as the part of one IP datagram that is contained in one TS packet, and when TS packets that contain intermediate parts or fragments of at least one IP datagram are erased, it becomes more difficult to build up the MPE-FEC frame. Referring now to FIG. 5, the PID 301.i.1.5 and the continuity counter 301.i.1.8 in the Transport Stream Packet header 301.i.1 provide additional information for positioning the remaining valid IP datagram parts.

Referring now to FIG. 3, the 32-bit CRC 151.3 covers a whole MPE 151 or MPE-FEC 152 section, i.e., up to 4,080 bytes of an IP datagram or up to 1,024 bytes of RS data. Its miss-detection probability is roughly 2⁻³²˜2.3E-10, which is significantly better than the miss-correction probability of the RS decoder (t=8 decoding) of the channel demodulator.

These two erasure information mechanisms each have advantages and disadvantages:

1) RS decoder
a) Pro: relatively small parts are erased;
b) Con: high miss-correction probability—this can be improved by decreasing the maximum number of symbols (bytes) to be corrected for errors from 8 to 7, which improves the miss-correction probability but increases the number of erased words;

one can still allow 8 symbol (byte) error corrections and flag the corresponding word with a low-priority erasure flag (also called “soft erasure”);

2) CRC
a) Pro: low miss-detection probability;
b) Con: moderate to large part are erased depending on the IP datagram size, which can be up to 4,080 bytes.

Instead of choosing one or the other erasure information mechanism (RS or CRC), the system and method of the present invention makes combined use of these erasure mechanisms: the RS decoder of the channel demodulator acts as the basic source of erasure information and the CRC is used for modifying so-called priority levels of erasure information. A preferred embodiment employs multi-level erasure information and defines four levels of erasure information: high-priority, medium-priority, low-priority, and no-priority erasure information.

A high-priority erasure flag is assigned to TS packets that have a transport error indicator (tei) equal to 1 and/or at least one missed IP datagram fragment that occurs during an IP de-encapsulation process (TS packets that have tei=1 are ignored by the TS de-multiplexer and lead to missed parts in an IP de-encapsulation process, see, e.g., co-pending patent application by the same inventors entitled Improved IP Datagram De-encapsulation, the entire contents of which are hereby incorporated by reference). Medium-priority erasure flags are assigned to TS packets in which the RS decoder of the channel demodulator has corrected the maximum number of errors (e.g., 8). Low-priority flags are not assigned yet and therefore have no specific meaning. No-priority flags means that the corresponding TS packet (or IP datagram fragment) is not suspicious at all (the number of corrected errors is smaller than 8).

A preferred embodiment provides an erasure memory 704 comprising at least two bits of erasure information for each byte of fragment resulting in 65 kbytes (4-levels) of erasure information for one MPE-FEC frame. The erasure information is almost constant in the column direction but when carrying out the MPE-FEC decoding the erasure information in the row direction is needed since RS code words are row-oriented.

In summary, a preferred embodiment uses 4 levels (priorities) of erasure information:
High priority (11), transport error indicator=1 and/or missed fragment→Hard erasure;
Medium priority (10), t=8 correction;
Low priority (01), not defined; and
No priority (00), transport error indicator=0 and t<8. →No erasure.
   An alternative embodiment of erasure priorities comprises the following:
High priority (11), missed fragments (i.e., no clue about the actual value of data is present);
Medium priority (10), transport error indicator=1, but PID value and continuity? counter gives sufficient confidence to believe that the payload contains a significant amount of correct data;
Low priority (01), t=8 correction;
No priority (00), transport error indicator=0 and t<8. →No erasure.
   After assignment of erasure priorities, the CRC that covers an MPE-section (i.e., section header and IP datagram) 151 is used for modifying erasure priorities in the erasure memory, if necessary. If, during an IP de-encapsulation, one or more missed IP datagram fragments occur (ignored TS packets), the calculation of the CRC is useless and the erasure priorities are not changed (at least one fragment has a high-priority flag). If there are no missed IP datagram fragments (no ignored TS packets), the CRC is calculated. Depending on the outcome of the CRC check, the soft erasures are promoted (CRC=1) or degraded (CRC=0).

Promotion of soft erasures means that they get a higher priority, i.e. when only two levels of erasures exist (soft and hard) this means that soft erasures are modified to hard erasures and fragments that are not erased get a soft erasure flag. Degradation of soft erasures means that erasures get a lower priority, i.e., when only two levels of erasure information exist one can reset the soft erasures.

FIG. 6 is a flow diagram of the promotion and degradation of soft erasure information. At step 601 it is determined if any parts, e.g., fragments, of an IP datagram have been missed, and if at least one fragment of an IP datagram has been missed, then at step 603 the missed fragments are hard erased by assigning them high priority (11) and the t=8 fragments are soft erased by assigning them medium priority (10). If there are no missed fragments for an IP datagram, then at step 602 the CRC is compared to zero; and if equal, then at step 604 soft erasures are either degraded or maintained; otherwise at step 605 soft erasures are promoted.

Since most RS decoders that support erasure decoding can handle only two levels of erasure information (i.e., erasure or no erasure), the different levels of erasure information must be ordered and granted in decreasing order of priority. Hence, first the high-priority erasures are granted, and if space remains (at most 64 erasures can be granted) medium and low priority erasures are granted.

Referring now to FIG. 7, a receiver 703 comprising a DVB-H de-encapsulator module 702 is modified to incorporate an erasure promotion/degradation management component 701 for using an erasure memory 704 to promote and degrade erasure information according to the system and method of the present invention. FIG. 8 illustrates a dedicated DVB-H network comprising a plurality of receiving devices modified according to the receiver of FIG. 7.

While the preferred embodiments of the present invention have been illustrated and described, it will be understood by those skilled in the art that the management frame, device architecture and methods as described herein are illustrative and various changes and modifications may be made and equivalents may be substituted for elements thereof without departing from the true scope of the present invention. In addition, many modifications may be made to adapt the teachings of the present invention to a particular situation without departing from its central scope. Therefore, it is intended that the present invention not be limited to the particular embodiments disclosed as the best mode contemplated for carrying out the present invention, but that the present invention include all embodiments falling within the scope of the appended claims.

1. An erasure prioritizing digital broadcasting receiver system (700) for handheld phones, comprising:
a channel demodulator comprising a decoder that assigns a received packet erasure priority to a received packet;
a de-encapsulator (702) that reconstructs a frame (100) from a sequence (301.i) of at least one received packet, said at least one received packet including a packet header (301.i.1) and corresponding packet payload (301.i.2), and assigns an erasure priority to each byte of the payload corresponding to a byte in the reconstructed frame (100) based on a transport error indicator flag (301.i.1.2) included in the packet header (301.i.1) and the received packet erasure priority assigned by the decoder; and
an erasure management module (701) that adjusts each said assigned erasure priority using a second erasure information.

2. The receiver of claim 1, wherein the assigned erasure priority is selected from the group of levels ordered from a highest level to a lowest level consisting of high priority, medium priority, low priority and no priority.

3. The receiver of claim 1, wherein the sequence of at least one packet payload further comprises at least one frame section (151) including a section header (151.1), a section payload (151.2) comprising at least one fragment, and a section cyclic redundancy check (CRC) (151.3) for the frame section, wherein a fragment is defined as a part of a section (151) that is contained in one packet and the CRC (151.3) is the second erasure information.

4. The receiver of claim 3, wherein a soft erasure is defined as one of a medium, low or no priority erasure; and the erasure management module (701) is further configured to one of degrade to a lower priority erasure or maintain an already assigned soft erasure if the CRC (151.3) is zero and otherwise promotes an already assigned soft erasure at least one level higher.

5. The receiver of claim 3, wherein the packet header (3010i.1) further comprises a packet identifier (PID) (301.i.1.5) and continuity counter (CC) (301.i.1.8).

6. The receiver of claim 5, wherein the pre-determined scheme is selected from the group consisting of:
A.1 high priority when at least one of the transport error indicator flag is set and at least one fragment of a section is missing;
A.2 medium priority for t=8 correction;
A.3 low priority, not defined; and
A.4 no priority when the transport error indicator flag is not set and t<8 correction; and
B.1 high priority when at least one fragment of a section is missing;
B.2 medium priority when the transport error indicator flag is set but PID and CC have values such that the payload contains a predetermined amount of correct data;
B.3 low priority for t=8 correction; and
B.4 no priority when the transport error indicator flag is not set and t<8 correction.

7. The receiver of claim 6, wherein:
a valid section is defined as a section consisting of valid fragments; and
when a valid section of a frame has been received, the erasure management module (701) uses the second erasure information to further adjust the erasure priority of each byte of the valid section.

8. The receiver of claim 7, wherein:
a soft erasure is defined as one of a medium, low or no-priority erasure; and
the erasure management module (701) is further configured to one of degrade to a lower priority erasure or maintain an already assigned soft erasure if the CRC (301.i.1.8) is zero and otherwise promotes an already assigned soft erasure at least one level higher.

9. A mobile terminal that receives digital broadcast information, comprising:
a demodulator that receives and assigns erasure priorities to each byte of a sequence of packets that includes at least one frame section (151) and a CRC (151.3) therefor, and a transport error indicator (tei) flag (301.i.1.2), a packet identifier (PID) (301.i.1.5) and continuity counter (CC) (301.i.1.8) in a header (301.i.1) of each packet (301.i) that has been transmitted by a digital broadcast transmitter, wherein the assignment is based on at least one of Reed-Solomon (RS) coding, tei, and PID;
a memory (704-705) that receives the sequence of at least one frame section (705) and assigned erasure priority (704) for each byte thereof; and
a de-encapsulator (702) that determines if a fragment of the at least one frame section is missing, wherein a fragment is defined as a part of a section that is contained in one packet; and an erasure management module (701) that adjusts each said assigned erasure priority (704) using the CRC (151.3) of the section (151).

10. The mobile terminal of claim 9, wherein the assigned erasure priority (704) is selected from the group of levels ordered from a highest level to a lowest level consisting of high priority, medium priority, low priority and no priority.

11. The mobile terminal of claim 10, wherein the assignment of erasure priority (704) is according to a scheme selected from the group consisting of:
A.1 high priority when at least one of the transport error indicator flags is set and at least one fragment of a section is missing;
A.2 medium priority for t=8 correction;
A.3 low priority, not defined; and
A.4 no priority when the transport error indicator flag is not set and t<8 correction; and
B.1 high priority when at least one fragment of a section is missing;
B.2 medium priority when the transport error indicator flag is set but PID and CC have values such that the payload contains a predetermined amount of correct data;
B.3 low priority for t=8 correction; and
B.4 no priority when the transport error indicator flag is not set and t<8 correction.

12. The receiver of claim 11, wherein a soft erasure is defined as one of a medium, low or no-priority erasure and the erasure management module (701) is further configured to one of degrade to a lower priority erasure or to maintain an already assigned soft erasure if the CRC (151.3) is zero and otherwise promotes an already assigned soft erasure at least one level higher.

13. A method for erasure prioritizing in a digital broadcast system, comprising the steps of:
transmitting, by a digital broadcast transmitter (801), a sequence of packets (301.i) that includes at least one frame section 151 and a CRC 151.3 therefor, and each packet (301.i) having a header (301.i.1) including a transport error indicator (tei) flag(301.i.1.2), a packet identifier (PID) (301.i.1.5), and continuity counter (CC) (301.i.1.8);
assigning an erasure priority to each byte of each frame section (151) selected from the group consisting of high priority, medium priority, low priority and no priority and based on at least one of a Reed-Solomon (RS) coding, tei, PID, and (CC); and
adjusting each said assigned erasure priority of the at least one frame section using the CRC (151.3).

14. The method of claim 13, wherein the assigning step further comprises the step of selecting an erasure priority ordered from a highest level to a lowest level according to a scheme selected from the group consisting of:
A.1 high priority when at least one of the transport error indicator flags is set and at least one fragment of a section is missing;
A.2 medium priority for t=8 correction;
A.3 low priority, not defined; and
A.4 no priority when the transport error indicator flag is not set and t<8 correction; and
B.1 high priority when at least one fragment of a section is missing,
B.2 medium priority when the transport error indicator flag is set but PID and CC have values such that the payload contains a predetermined amount of correct data;
B.3 low priority for t=8 correction; and
B.4 no priority when the transport error indicator flag is not set and t<8 correction.

15. The method of claim 14, wherein a soft erasure is defined as one of a medium, low or no-priority erasure and the adjusting step further comprises the steps of:
degrading to a lower priority erasure or maintaining an already assigned soft erasure if the CRC (151.3) is zero; and otherwise
promoting an already assigned soft erasure at least one level higher.

16. A computer-readable medium containing computer-executable instructions for erasure prioritizing by performing the steps recited in claim 13.

17. A computer-readable medium containing computer-executable instructions for erasure prioritizing by performing the steps recited in claim 14.

18. A computer-readable medium containing computer-executable instructions for erasure prioritizing by performing the steps recited in claim 16.
